(19) United States
(12) Patent Application Publication
(10) Pub. No.: US 2009/0147906 A1
(43) Pub. Date: Jun. 11, 2009

(54) METHODS OF GENERATING ENERGETIC PARTICLES USING NANOTUBES AND ARTICLES THEREOF

(76) Inventors: Christopher H. Cooper, Windsor, VT (US); James F. Loan, Tumers Falls, MA (US); William K. Cooper, Santa Fe, NM (US); Alan G. Cummings, Hartland, VT (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/258,568

(22) Filed: Oct. 27, 2008

Related U.S. Application Data
(63) Continuation of application No. 11/633,524, filed on Dec. 5, 2006, now abandoned.
(60) Provisional application No. 60/741,874, filed on Dec. 5, 2005.
(60) Provisional application No. 60/777,577, filed on Mar. 1, 2006.

(51) Int. Cl. G21G 1/00

(52) U.S. Cl. 376/156; 977/902

(57) ABSTRACT

There is disclosed a method of generating energetic particles, which comprises contacting nanotubes with a source of hydrogen isotopes, such as D₂O, and applying activation energy to the nanotubes. In one embodiment, the hydrogen isotopes comprises protium, deuterium, tritium, and combinations thereof. There is also disclosed a method of transmuting matter that is based on the increased likelihood of nuclei interaction for atoms confined in the limited dimensions of a nanotube structure, which generates energetic particles sufficient to transmute matter and exposing matter to be transmuted to these particles.

This application claims the benefit of domestic priority under 35 USC §119(e) to U.S. Application Nos. 60/741,874, filed Dec. 5, 2005, and 60/777,577, filed Mar. 1, 2006, both of which are incorporated by reference herein.

Disclosed herein are methods of generating energetic particles, by contacting nanotubes with hydrogen isotopes in the presence of activation energy, such as thermal, electromagnetic, or the kinetic energy of particles. Also disclosed are methods of transmuting matter by exposing such matter to the energetic particles produced according to the disclosed method.

A need exists for alternative energy sources to alleviate our society's current dependence on hydrocarbon fuels without further impact to the environment. The inventors have developed multiple uses for nanotubes and devices that use such nanotubes. The present disclosure combines the unique properties of nanotubes and in one embodiment carbon nanotubes, in a novel manifestation designed to meet current and future energy needs in an environmentally friendly way.

Devices powered with nanotube based nuclear power systems may substantially change the current state of power distribution. For example, nanotube based nuclear power systems may reduce, if not eliminate, the need for power distribution networks; chemical batteries; energy scavenger devices such as solar cells, windmills, hydroelectric power stations; internal combustion, chemical rocket, or turbine engines; as well as all other forms of chemical combustion for the production of power.

### SUMMARY OF THE INVENTION

Accordingly, there is disclosed a method of generating energetic particles, which comprises contacting nanotubes with hydrogen isotopes and applying activation energy to the nanotubes. In one embodiment, the hydrogen isotopes comprises protium, deuterium, tritium, and combinations thereof. In addition, the source of hydrogen isotopes may be in a solid, liquid, gas, plasma, or supercritical phase. Alternatively, the source of hydrogen isotopes may be bound in a molecular structure.

There is also disclosed a method of transmuting matter that comprises contacting nanotubes with a source of hydrogen isotopes, applying activation energy to the nanotubes, producing energetic particles, and contacting the matter to be transmuted with the energetic particles. As used herein, transmutable matter is matter that is transformed from one element or isotope to another element or isotope.

### BRIEF DESCRIPTION OF THE DRAWINGS

FIG. 1 is a schematic of a rotator type reactor for a liquid phase reaction with a He³ detector used according to the present disclosure.

FIG. 2 is a schematic of a rotator type according to FIG. 1, wherein the He³ detector has been replaced with an array of Germanium detectors.

FIG. 3 is a schematic of a reactor without a separate electrode for electrolysis of the liquid phase used according to the present disclosure.

FIG. 4 is a schematic of a reactor according to FIG. 3, further including a separate electrode for electrolysis of the liquid phase.

FIG. 5 is a schematic of a reactor for a gas phase reaction used according to the present disclosure.

FIG. 6 is a plot of the number of energetic particles generated using the reactor of FIG. 4.

### DETAILED DESCRIPTION OF THE INVENTION

### A. Definitions

The following terms or phrases used in the present disclosure have the meanings outlined below:

The term “fiber” or any version thereof, is defined as a high aspect ratio material. Fibers used in the present disclosure may include materials comprised of one or many different compositions.

The term “nanotube” refers to a tubular-shaped, molecular structure generally having an average diameter in the inclusive range of 25 Å to 100 nm. Lengths of any size may be used.

The term “carbon nanotube” or any version thereof refers to a tubular-shaped, molecular structure composed primarily of carbon atoms arranged in a hexagonal lattice (a graphene sheet) which closes upon itself to form the walls of a seamless cylindrical tube. These tubular sheets can either occur alone (single-walled) or as many nested layers (multi-walled) to form the cylindrical structure.

The phrase “environmental background radiation” refers to ionizing radiation emitted from a variety of natural and artificial sources including terrestrial sources and cosmic rays (cosmic radiation).

The term “functionalized” (or any version thereof) refers to a nanotube having an atom or group of atoms attached to the surface that may alter the properties of the nanotube, such as zeta potential.

The term “doped” carbon nanotube refers to the presence of ions or atoms, other than carbon, into the crystal structure of the rolled sheets of hexagonal carbon. Doped carbon nanotubes means at least one carbon in the hexagonal ring is replaced with a non-carbon atom.

The terms “transmuting,” “transmutation” or derivatives thereof is defined as a change of the state of the nucleus, whether its changing the number of protons or neutrons in the nucleus or changing the energy in the nucleus through capture or emission of a particle. Transmuting matter is thus defined as changing the state of the nucleus comprising the matter.

In one embodiment, there is disclosed a method of producing energetic particles from the transmutation of isotopes utilizing a nanotube structure. In this embodiment, transmutation is a change to the nuclear composition of an isotope accompanied by a release or adsorption of energy. In order to generate energy from the combination or division of stable isotopes the addition of activation energy may be required.

This activation energy may come in the form of electromagnetic stimulation either directly or indirectly which imparts momentum temperatures, pressure or electromagnetic fields to the isotope. The initial activation energy may be in the form of a current pulse or electromagnetic radiation. Furthermore, activation energy may come in the form of energy produced from the transmutation reactions described herein, also known as a chain reaction.

In certain isotopic transmutation reactions, activation energy is the energy required to overcome the coulomb repulsion that arises when two nuclei are brought close together. The primary isotope for such a reaction is deuterium (²H), although hydrogen (¹H), tritium (³H), and helium three (³He) can also be used on the way to producing energy and helium four (⁴He). Included by reference is a list of isotopes which can be used for energy producing transmutation reactions and can found on 507-521 of “Modern Physics” by Hans C. Ohanian 1987, which pages are herein incorporated by reference.

In order to overcome the coulomb repulsion of the isotopes required for transmutation, activation energy may be supplied in the form of thermal, electromagnetic, or the kinetic energy of a particle. Electromagnetic energy comprises one or more sources chosen from x-rays, optical photons, α, β, or γ-rays, microwave radiation, infrared radiation, ultraviolet radiation, phonons, cosmic rays, radiation in the frequencies ranging from gigahertz to terahertz, or combinations thereof.

The activation energy may also comprise particles with kinetic energy, which are defined as any particle, such as an atom or molecule, in motion. Non-limiting embodiments include protons, neutrons, anti-protons, elemental particles, and combinations thereof. As used herein, “elemental particles” are fundamental particles that cannot be broken down to further particles. Examples of elemental particles include electrons, anti-electrons, mesons, pions, hadrons, leptons (which is a form of electron), baryons, radio isotopes, and combinations thereof.

Other particles that may be used as activation energy in the disclosed method include those mentioned by reference at pages 460-494 of “Modern Physics” by Hans C. Ohanian, which pages are herein incorporated by reference.

Similarly, the energetic particles generated by the disclosed method may comprise the same energetic particles previously described, namely neutrons, protons, electrons, beta radiation, alpha radiation, mesons, pions, hadrons, leptons, baryons, and combinations thereof. In other words, the energetic particles produced by the disclosed method may comprise the same energetic particles used to initiate the reaction.

Because energy production required for the transmutation reaction described herein uses activation energy, one can control the energy produced by controlling the amount of activation energy present or the rate at which the isotopes are being fed in the inventive process to the nanotube structure. For example, the generation of energy can be significantly reduced by freezing a nanotube/heavy water mixture, thus robbing thermal energy from the nuclear transmutation process and slowing diffusion of deuterium into the nanotubes, such as carbon nanotubes.

In one embodiment, transmuting matter may be accomplished by contacting matter with a nanotube structure, confining the matter within a dimension of the nanotube structure, and exposing the nanotube structure with the matter confined therein to activation energy.

Without being bound by any theory the methods for generation of energetic particles and transmutation reactions described herein are a manifestation, at least in part, to the nanotube structure. It is believed that when matter on the atomic scale is confined to the limited dimensions of a nanotube structure, the nucleus of the atoms comprising the matter will more likely be subject to interaction and thus transmutation of the matter. In other words, nanoscale confinement increases the probabilities that nuclei of matter will interact. Similar theories have been described as screening in a one-dimensional Bose gas, a description of which can be found in the article by N. M. Bogolyubov et al., Complete Screening in a One-Dimensional Bose Gas, Zapiski Nauchnykh Seminarov Leningradskogo Otdeleniya Matematicheskogo Instituta im. V.A. Steklova AN SSSR, Vol. 150 pp. 3-6, 1986.

Thus, in one embodiment, it is believed that with a high density electron plasma inside the confined system of a carbon nanotube when a current, such as in the form of a pulse, is applied to the carbon nanotube, and in the presence of deuterium, coulomb repulsion may be reduced or eliminated. Electrons may be in very close proximity to the nuclei, thus on average canceling out the coulomb repulsion between deuterium isotopes. This in turn should decrease the required activation energy for transmutation.

Any nanoscaled structure having a hollow interior that assists or enables nanoscale confinement, and that is capable of withstanding the internal conditions associated with the disclosed method, can be used in the disclosed process.

In one embodiment, the nanotubes comprises carbon and its allotropes. For example, the carbon nanotube used according to the present disclosure may comprise a multi-walled carbon nanotube having a length ranging from 500 μm to 10 cm, such as from 2 mm to 10 mm. Nanotube structures according to the present disclosure may have an inside diameter ranging up to 100 nm, such as from 25 Å to 100 nm.

The nanotube material may also comprise a non-carbon material, such as an insulating, metallic, or semiconducting material, or combinations of such materials.

It is to be appreciated that the hydrogen isotopes may be located within the interior of a nanotube, the space between the walls of a multi-walled nanotube (when used), inside at least one loop formed by one or more nanotubes, or combinations thereof.

In one embodiment, the nanotubes may be aligned end to end, parallel, or in any combination there of. In addition, or alternatively, the nanotubes may be fully or partially coated or doped by least one atomic or molecular layer of an inorganic material.

In certain embodiments, the methods of transmuting matter may be enhanced when the nanotube structure catalytically interacts with the matter confined therein. This may be done by either choosing a particular nanotube, such as carbon, or by doping or coating the nanotube with a molecule that can alter the amount or type of activation energy needed to initiate the disclosed reactions.

As used herein, “catalyst” any word derived therefrom, is defined as a substance that changes the activation energy. In one embodiment, changing the activation energy is defined as lowering the energy required for transmutation reaction(s) to occur.

When the nanotube structure further acts as a catalyst, it may do so as an integrator, taking many low energy photons, phonons or particles and additively delivering their energy to the transmutation nuclei. The previously mentioned forms of activation energy may also be used in such a process.

In some cases, activation energy may result from the sum of multiple forms of energy, such as x-rays nanotube capture coincident with electron nuclear scattering to drive the transmutation reaction, such as the transmutation of deuterium into ³He and neutrons.

In certain embodiments, it is possible to produce a chain reaction by loading hydrogen isotopes within the nanotube so that energy released from one transmutation event will drive more transmutation events.

As stated, method of transmuting matter may lead to the generation of energy, from the release of energetic particles. In non-limiting embodiments, the energy generated from the disclosed method may comprise neutrons tritons, helium isotopes and protons with kinetic energy.

The nanotube structure disclosed herein may comprise single walled, double walled or multi-walled nanotubes or combinations thereof. The nanotubes may have a known morphology, such as those described in Applicants co-pending applications, including U.S. patent application Ser. No. 11/111,736, filed Apr. 22, 2005, U.S. patent application Ser. No. 10/794,056, filed Mar. 8, 2004 and U.S. patent application Ser. No. 11/514,814, filed Sep. 1, 2006, all of which are herein incorporated by reference.

Some of the above described shapes are more particularly defined in M. S. Dresselhaus, G. Dresselhaus, and P. Avouris, eds. Carbon Nanotubes: Synthesis, Structure, Properties, and Applications, Topics in Applied Physics. 80. 2000, Springer-Verlag; and “A Chemical Route to Carbon Nanoscrolls, Lisa M. Viculis, Julia J. Mack, and Richard B. Kaner; Science, 28 Feb. 2003; 299, both of which are herein incorporated by reference.

When nanotube structures having the foregoing morphologies are employed, the confinement dimension, defined as the dimension in which the matter undergoing transmutation is confined, is chosen from the interior of a nanotube, the space between the walls of a multi-walled nanotube, inside at least one loop formed by one or more nanotubes, or combinations thereof.

As previously stated, the method according to the present disclosure typically uses an activation energy to assist in transmutation. Non-limiting examples of such activation energy includes microwave radiation, infrared radiation, thermal energy, phonons, optical photons, ultraviolet radiation, x-rays, γ-rays, α-radiation, β-radiation, and cosmic rays.

It is understood that the nanotube structure may comprise a network of nanotubes which are optionally in a magnetic, electric, or otherwise electromagnetic field. In one non-limiting embodiment, the magnetic, electric, or electromagnetic field can be supplied by the nanotube structure itself.

In addition, the method may further include applying an alternating current direct current or current pulses to the nanotube structure or combinations thereof.

The nanotube structure disclosed herein may have a epitaxial layers of metals or alloys.

The composition of the nanotube is not known to be critical to the methods described herein. Without being bound by theory, it appears that the confinement of the species within the nanotube may be responsible for the effects that are disclosed herein, rather than some interaction of the carbon in the nanotubes used in the disclosed embodiment and the species that was energized by the confinement, deuterium. For this reason, while the nanotubes describe herein are specifically described as carbon, more generally, they can comprise ceramic (including glasses), metallic (and their oxides), organic, and combinations of such materials.

The morphology (geometric configuration) of the nanotubes, other than providing confinement in a dimension for the species being energized, is not known to be critical. In one embodiment, there is disclosed a multi-walled, carbon nanotube. The nanotube structure disclosed herein may have single or multiple atomic or molecular layers forming a shell or coating on the nanotubes described herein. In addition to such coatings, the nanotube structure may be doped by least one atomic or molecular layer of an inorganic or organic material.

A description of coatings for nanotubes, as well as methods of coating nanotubes, are described in applicants co-pending application, which were previously incorporated by reference, i.e., U.S. patent application Ser. No. 11/111,736, filed Apr. 22, 2005, U.S. patent application Ser. No. 10/794,056, filed Mar. 8, 2004 and U.S. patent application Ser. No. 11/514,814, filed Sep. 1, 2006.

The method described herein may further comprise functionalizing the carbon nanotubes with at least one organic group. Functionalization is generally performed by modifying the surface of carbon nanotubes using chemical techniques, including wet chemistry or vapor, gas or plasma chemistry, and microwave assisted chemical techniques, and utilizing surface chemistry to bond materials to the surface of the carbon nanotubes. These methods are used to “activate” the carbon nanotube, which is defined as breaking at least one C—C or C-heteroatom bond, thereby providing a surface for attaching a molecule or cluster thereto.

Functionalized carbon nanotubes may comprise chemical groups, such as carboxyl groups, attached to the surface, such as the outer sidewalls, of the carbon nanotube. Further, the nanotube functionalization can occur through a multi-step procedure where functional groups are sequentially added to the nanotube to arrive at a specific, desired functionalized nanotube.

Unlike functionalized carbon nanotubes, coated carbon nanotubes are covered with a layer of material and/or one or many particles which, unlike a functional group, is not necessarily chemically bonded to the nanotube, and which covers a surface area of the nanotube.

Carbon nanotubes used herein may also be doped with constituents to assist in the disclosed process. As stated, a “doped” carbon nanotube refers to the presence of ions or atoms, other than carbon, into the crystal structure of the rolled sheets of hexagonal carbon. Doped carbon nanotubes means at least one carbon in the hexagonal ring is replaced with a non-carbon atom.

Also disclosed is a method of transmuting matter that comprises contacting nanotubes with a source of hydrogen isotopes, applying activation energy to the nanotubes, producing energetic particles, and contacting the matter to be transmuted with the energetic particles.

A fraction of the energy produced from transmutation in the form of radiation may be used directly to drive second generation transmutation reactions. This method can be used to continually generate power to the levels required for consumption.

In one embodiment, the method described herein may be used to transmute isotopes having a long half-life and considered to be radioactive pollutants into isotopes with a shorter half-life. This may be accomplished via neutron capture. In this embodiment, it may be desirable to feed the nanotube with deuterium since many neutrons packed closely together in the carbon nanotubes can be captured by the target isotope. The abundance of neutrons in the nucleus will drive transmutation reactions, this reducing the half-life of a radioactive isotope from hundreds or thousands of years to milliseconds.

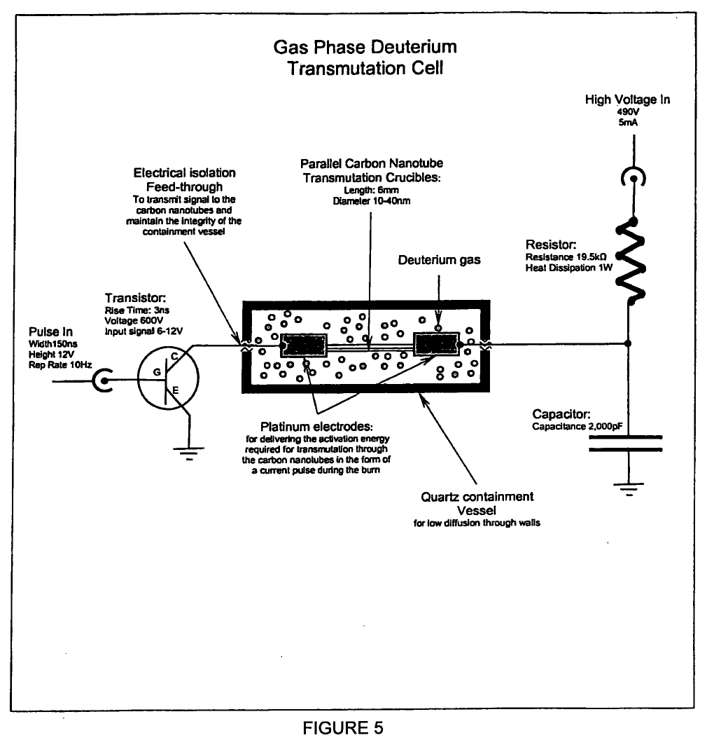

In another embodiment, the transmutation of deuterium into ³He and neutrons may be performed by contacting carbon nanotubes with a deuterium gas and activation energy. In this embodiment, the deuterium is kept in high concentration by a confinement vessel that surrounds the element components, e.g., the deuterium gas, the carbon nanotubes, and attached electrodes. In addition, the carbon nanotubes should be bundled to make electrical contact with the electrodes at either end of the bundle. Wires are attached to the electrode and feed the carbon nanotubes with activation energy from a circuit that produces a 400V pulse for 10 ns. A schematic of this embodiment is shown in FIG. 5.

The present disclosure is further illustrated by the following non-limiting examples, which are intended to be purely exemplary of the disclosure.

### EXAMPLES

### Example 1

### Production of Energetic Particles Using Treated Carbon Nanotubes

a) Production of Carbon Nanotube Material

5 g of carbon nanotubes were mixed with 250 ml of reagent grade nitric acid at room temperature. The carbon nanotubes were multi-walled, with diameters ranging from 10 nm to 50 nm and lengths ranging from 100 nm to 100 um. After 20 minutes, the carbon nanotubes were removed from the nitric acid and washed with water three times. The carbon nanotubes were dried in an oven set above room temperature to remove water. From that batch, 100 mg of the carbon nanotubes were combined with 3540 ml of 99.9% pure D₂O in a 50 ml glass beaker (Sample A). The D₂O was taken from a new 250 gram sample that was purchased from Sigma Aldrich (Part number 151882-250G, Batch number 08410KC).

b) Measurements on Carbon Nanotube Material

Various energetic particles emitted from Sample A were measured in the following manner:

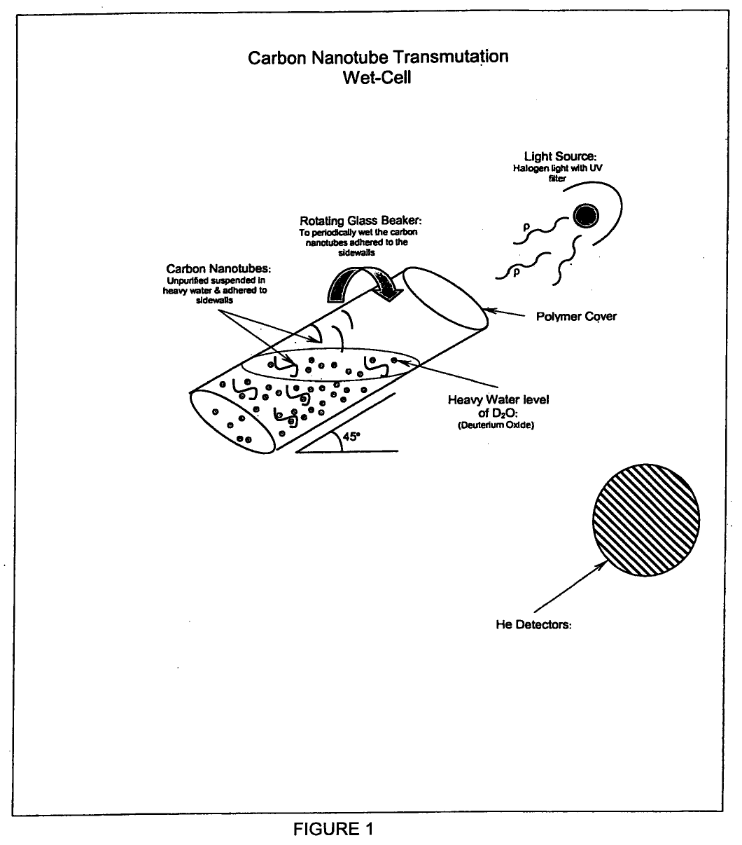

Sample A was covered with clear plastic wrap to minimize evaporation of the D₂0 and water absorption into the hydroscopic D₂0. It was then placed in a rotatable sample holder, which was held at a 45 degree angle relative to the floor and rotated at about 1 rpm during measurement so as to keep the surface carbon nanotubes at least partially wet. A schematic of this rotating sample holder is shown in FIG. 1.

Energy above background was measured using a ³He Neutron detector and a NaI (sodium iodide) gamma/x-ray detector. Background measurements were made with no sample present. Sample A was initially measured in a dark room. The measurement was repeated with the sample irradiated by a UV filtered halogen light. A second sample (B), identical in composition and morphology to sample A was prepared. Sample B was irradiated separately with (a) a UV filtered halogen light and (b) a red laser.

While all samples, including that measured in the dark room, showed a positive bias above background, enhanced signal was noticed when a light source was used, with the strongest response occurring for the UV filtered halogen light.

This example shows that by combining treated carbon nanotubes with D₂0, energetic particles were produced.

### Example 2

### Production of Energetic Particles Using Untreated Carbon Nanotubes

a) Production of Carbon Nanotube Material

This example was substantially similar to Ex. 1, with the exception that untreated multi-walled carbon nanotubes were used in this example. The carbon nanotubes had diameters ranging from 10 nm to 50 nm and lengths ranging from 100 nm to 100 um. About 100 mg of the carbon nanotubes were combined with 35-40 ml of 99.9% pure D₂O in a 50 ml glass beaker.

b) Measurements on Carbon Nanotube Material

Energetic particles emitted from the sample made according to this invention were measured in the following manner:

As in Example 1, the sample according to this example was covered with clear plastic wrap to minimize evaporation of the D₂0 and water absorption into the hydroscopic D₂0. It was then placed in a rotatable sample holder, which was held at a 45 degree angle relative to the floor and rotated at about 1 rpm during measurement so as to keep the surface carbon nanotubes at least partially wet.

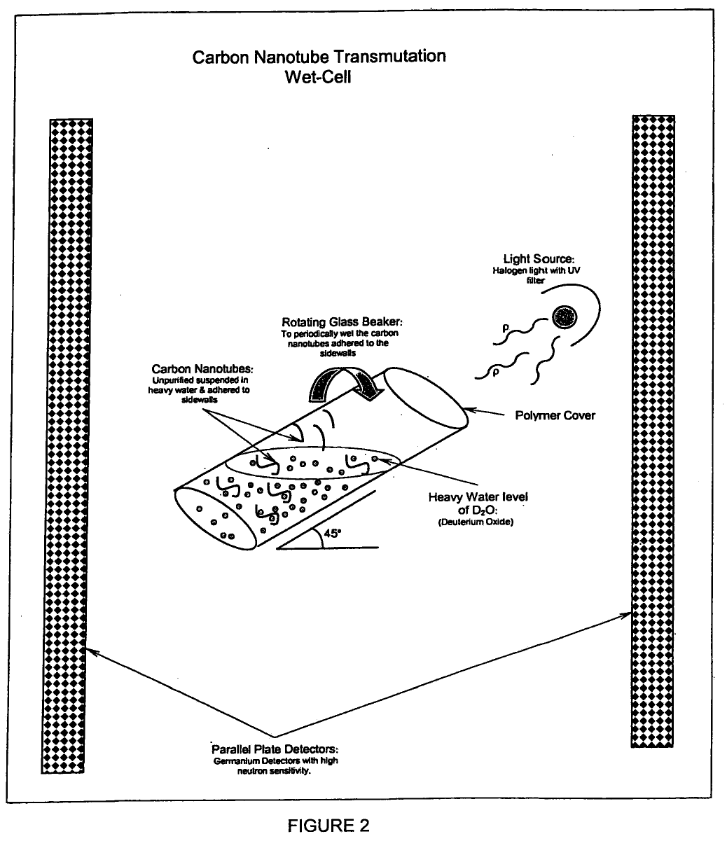

A schematic of the set-up used in this Example is shown in FIG. 2, which is similar to FIG. 1, with the ³He detector being replaced by an array of Germanium detectors. In particular, prior to the application of the activation energy, two arrays of Germanium neutron detectors, placed on either side of the apparatus, were calibrated to determine the background rate of neutrons at the site of the experiment. The detectors were state of the art neutron detectors that were the property of the Lawrence Livermore National Laboratories and the manner in which the detectors operated was proprietary to their owners.

Background measurements were made with no sample present. The measurement was made while the sample was irradiated by a UV filtered halogen light. While all measurements including background showed a positive bias above background, enhanced signal was noticed when the UV filtered halogen light was applied.

This example shows that by combining untreated carbon nanotubes with D₂0, while applying activation energy, energetic particles were produced.

### Example 3

### Production of Energetic Particles Via Transmutation in a Liquid Phase—without an Electrolysis Electrode

In this example the nanotubes were commercially pure carbon nanotubes obtained from NanoTechLabs (NanoTechLabs Inc., 409 W. Maple St., Yadkinville, N.C. 27055). They had a length of approximately 3 mm, with a 6 member ring structure and were straight in orientation. The carbon nanotubes were substantially defect free and were not treated prior to use in the device.

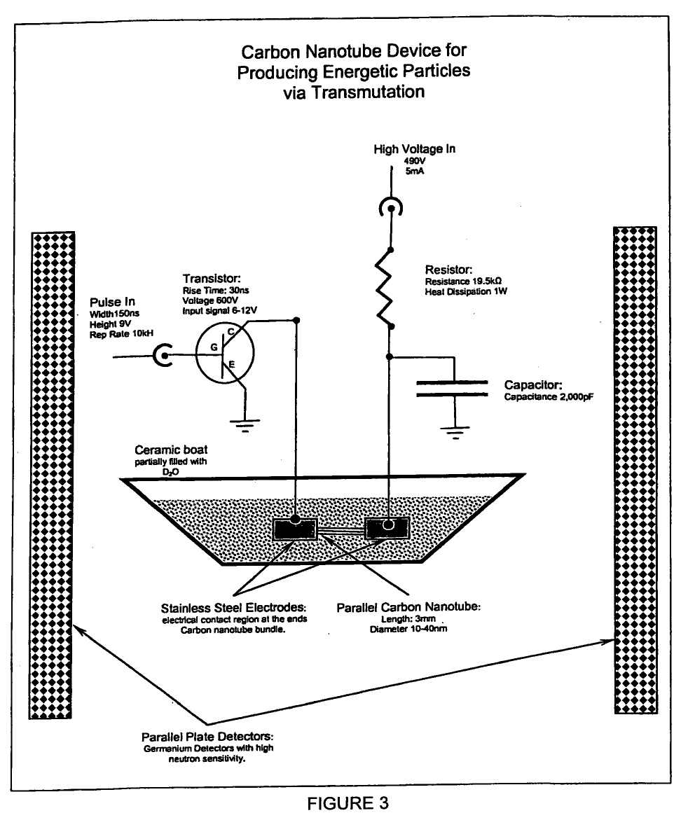

A bundle of aligned carbon nanotubes containing approximately 1,000 individual nanotube was connected to stainless steel electrodes at each end of the bundle. The carbon nanotube electrode system was measured to have approximately 200Ω of resistance. One nanotube electrode was connected through a capacitor to ground and to a 19.5 μl resistor connected to the high voltage supply. See FIG. 3. The other nanotube electrode was connected through a 30 ns rise time transistor to ground. The gate on the transistor was connected to a pulse generator.

The carbon nanotube electrode system was submerged in 2 grams of liquid D₂O in a ceramic reactor boat at room temperature and pressure. A voltage was applied to the carbon nanotubes as a 200 Volt spike for a duration in the range of from 200 nanoseconds at a repetition rate of approximately 10 KHz.

A signal generator delivered a 150 ns wide pulse at 9V to the transistor to trigger the discharge of the capacitor through the deuterium loaded carbon nanotubes. Neutron bursts were produced for a 2 hr time period before the stainless steel electrodes corroded due to electro corrosion and no longer made contact with the carbon nanotubes. The data acquisition system recorded data above background for this time period.

Prior to the application of the voltage two arrays of Germanium neutron detectors, placed on either side of the apparatus, were calibrated to determine the background rate of neutrons at the site of the experiment. The detectors were state of the art neutron detectors that were the property of the Lawrence Livermore National Laboratories and the manner in which the detectors operated was proprietary to their owners.

Prior to the application of voltage, the detectors intermittently detected neutron with no observed periodicity of detections. This was comparable to background radiation. After the voltage was applied to the carbon nanotube again the detectors detected neutrons intermittently. The neutrons were detected in short duration bursts and as a low level steady stream above background with the detection event being from four to 100 times the magnitude of the background detections. When the application of the voltage was discontinued the detections were again characteristic in magnitude of those at background levels and no periodicity of the bursts was observed. The kinetic energy of the detected neutron could not be measured with the equipment used.

The experimental apparatus had no provision for measuring any heat generated during the operation of the device. Nor was there any provision for testing the composition of gases that may have been created during the process.

### Example 4

### Production of Energetic Particles Via Transmutation in a Liquid Phase—with an Electrolysis Electrode

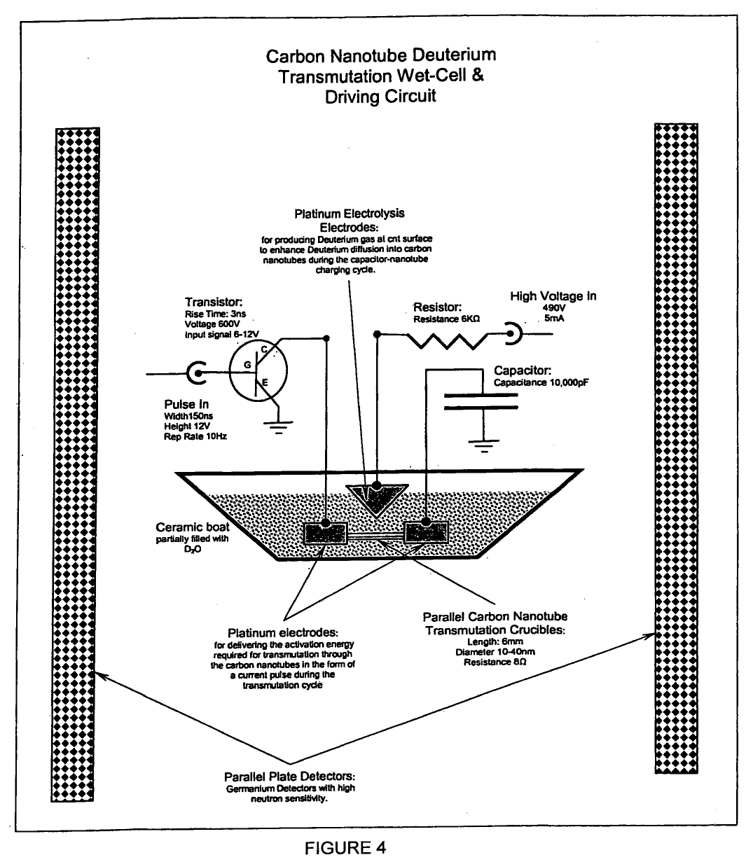

In this example the nanotubes were commercially pure carbon nanotubes obtained from NanoTechLabs (NanoTechLabs Inc., 409 W. Maple St., Yadkinville, N.C. 27055). They had a length of approximately 6 mm, with a 6 member ring structure and were straight in orientation. The carbon nanotubes were substantially defect free and were not treated prior to use in the device. A bundle of aligned carbon nanotubes containing approximately 1,000 individual nanotube was connected to platinum electrodes at each end of the bundle. The carbon nanotube electrode system was measured to have approximately 8Ω of resistance. One nanotube electrode was connected through a capacitor to ground. The other nanotube electrode was connected through a transistor to ground. A third electrolysis electrode was held in close proximity to the center of the carbon nanotube bundle and was connected to a 490V 5 mA power supply through a 6KΩ resistor. A schematic and description of this set-up is shown in FIG. 4.

The carbon nanotube electrode system was submerged in 2 grams of liquid D₂O in a ceramic reactor boat at room temperature and pressure. A voltage was applied to the carbon nanotubes as a 490 Volt spike for a duration in the range of from 10 to 100 nanoseconds at a repetition rate of approximately 730 Hz. During the millisecond the capacitor was charging, the charging current was also used to perform electrolysis of the D₂O to produce D₂ gas at the nanotube surface. Electrolysis was performed to increase diffusion of D₂ into the carbon nanotube. A signal generator delivered a 150 ns wide pulse at 9V to the transistor to trigger the discharge of the capacitor through the deuterium loaded carbon nanotubes. Neutron bursts were produced and recorded by a data acquisition system that were not present in the background.

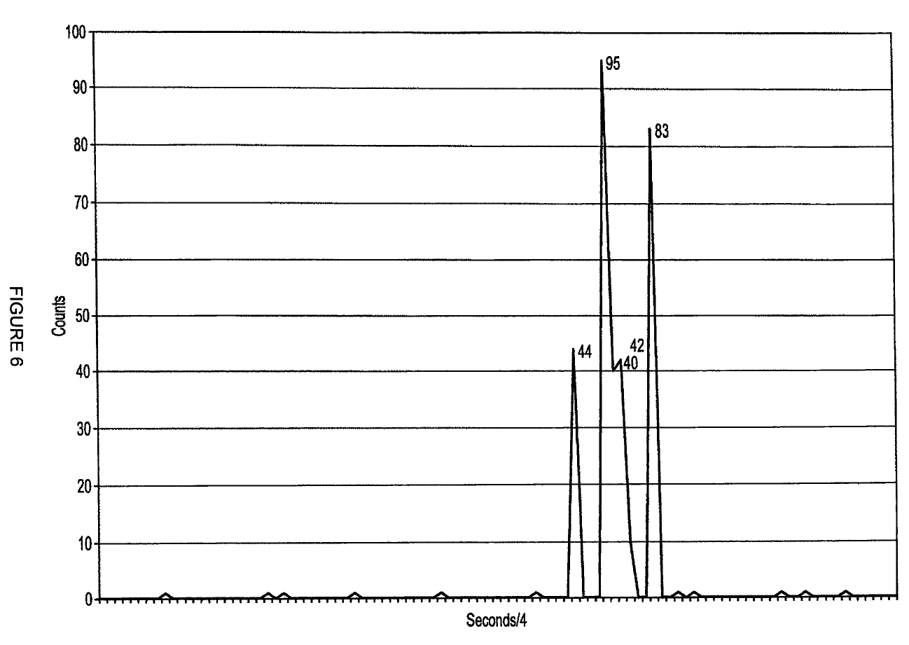

A plot of the number of energetic particles generated according to this example is shown in FIG. 6.

Prior to the application of the voltage two arrays of Germanium neutron detectors, placed on either side of the apparatus, were calibrated to determine the background rate of neutrons at the site of the experiment. The detectors were state of the art neutron detectors that were the property of the Lawrence Livermore National Laboratories and the manner in which the detectors operated was proprietary to their owners.

Prior to the application of voltage, the detectors intermittently detected neutron with no observed periodicity of detections. This was comparable to background radiation. After the voltage was applied to the carbon nanotube again the detectors detected neutrons intermittently. As shown in FIG. 6, the neutrons were detected in short duration bursts with the detection event being from four to ten thousand times the magnitude of the background detections. In addition, over time a periodicity of the bursts was observed, the frequency of which was approximately 10 minutes. When the application of the voltage was discontinued the detections were again characteristic in magnitude of those at background levels and no periodicity of the bursts was observed. The kinetic energy of the detected neutron could not be measured with the equipment used.

The experimental apparatus had no provision for measuring any heat generated during the operation of the device. Nor was there any provision for testing the composition of gases that may have been created during the process. The composition of the liquid remaining after the experiment was determined and the amount of heavy water in the sample had decreased.

The data generated from this example was statistically analyzed via a Hurst analysis to determine the statistical significance of the results. A Hurst analysis is a correlated analysis of random and non-random occurrences of events yielding a figure of merit. A figure of merit centered around 0.5 indicates random data. A figure of merit approaching 1.0 indicates positive correlation. A figure of merit approaching zero indicates anti-correlation. Data according to this example approached 0.9 indicating high positive correlation. In other words, the statistical analysis of the data from this example provides strong evidence of non-random signal.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A method of generating energetic particles, said method comprising contacting nanotubes with hydrogen isotopes, and applying activation energy to said nanotubes.

2. The method of claim 1, wherein said hydrogen isotopes comprises protium, deuterium, tritium, and combinations thereof.

3. The method of claim 1, wherein said hydrogen isotopes are provided from a source that is in a solid, liquid, gas, plasma, or supercritical phase.

4. The method of claim 1, wherein said hydrogen isotopes are provided from a source that are bound in a molecular structure.

5. The method of claim 1, wherein hydrogen isotopes are provided via D₂O.

6. The method of claim 1, wherein said activation energy comprises thermal, electromagnetic, or the kinetic energy of a particle.

7. The method of claim 6, wherein said electromagnetic energy comprises one or more sources chosen from x-rays, optical photons, γ-rays, microwave radiation, infrared radiation, ultraviolet radiation, phonons, radiation in the frequencies ranging from gigahertz to terahertz, or combinations thereof.

8. The method of claim 6, wherein said particle containing kinetic energy is chosen from neutrons, protons, electrons, beta radiation, alpha radiation, mesons, pions, hadrons, leptons, baryons, and combinations thereof.

9. The method of claim 1, wherein said energetic particles comprise neutrons, protons, electrons, beta radiation, alpha radiation, mesons, pions, hadrons, leptons, baryons, and combinations thereof.

10. The method of claim 1, wherein said nanotubes comprise carbon nanotubes.

11. The method of claim 1, wherein said nanotube is a multi-walled carbon nanotube.

12. The method of claim 1, wherein said nanotube is a multi-walled carbon nanotube has a length ranging from 500 μm to 10 cm.

13. The method of claim 1, wherein said nanotube is a multi-walled carbon nanotube having a length ranging from 2 mm to 10 mm.

14. The method of claim 1, wherein said hydrogen isotopes are located within the interior of a nanotube, the space between the walls of a multi-walled nanotube, inside at least one loop formed by one or more nanotubes, or combinations thereof.

15. The method of claim 1, further comprising forming a bundle of carbon nanotubes and providing activation energy in the form of electrical energy, to the bundle.

16. The method of claim 13, wherein said electrical energy is in the form of an electrical pulse.

17. The method of claim 1, wherein said nanotubes are aligned end to end, parallel, or in any combination thereof.

18. The method of claim 1, wherein said nanotube structure has an inside diameter ranging up to 100 nm.

19. The method of claim 1, wherein the said nanotube is comprised of insulating, metallic, or semiconducting materials and combinations of such materials.

20. The method of claim 1, wherein said nanotubes consist essentially of carbon and its allotropes.

21. The method of claim 1, further comprising at least partially coating or doping least one atomic or molecular layer of an inorganic material prior to applying said activation energy.

22. The method of claim 1, wherein said activation energy comprises environmental background radiation.

23. The method of claim 22, wherein said environmental background radiation comprises cosmic rays.

24. A method of transmuting matter, said method comprising contacting nanotubes with a source of hydrogen isotopes, applying activation energy to said nanotubes, producing energetic particles, and contacting the matter to be transmuted with said energetic particles.
